(19) United States
(12) Patent Application Publication
(10) Pub. No.: US 2004/0088118 A1
(43) Pub. Date: May 6, 2004

(54) Method for generating a hierarchical topologican tree of 2d or 3d-structural formulas of chemical compounds for property optimisation of chemical compounds

(76) Inventors: Axel Jensen, Velbert (DE); Stefan Seidler, Munchen (DE)

Correspondence Address: Jeffrey M Greenman, Bayer Corporation, 400 Morgan Lane, West Haven, CT, 06516, US

(21) Appl. No.: 10/472,028

(22) PCT Filed: Mar. 12, 2002
(86) PCT No.: PCT/EP02/02685

(30) Foreign Application Priority Data
Mar. 15, 2001 (GB) 0106441.9

(51) Int. Cl. G01N 31/00

(52) U.S. Cl. 702/30

(57) ABSTRACT

The invention concerns a new method for automatically and dynamically generating hierarchical topological trees of 2D- or 3D-structural formulas for structurally characterized chemical compounds, especially drug-like molecules, wherein the molecular graph of each 2D- or 3D-structure for a chemical compound is analyzed in terms of topological key features, the Largest Topological Substructure (LTS) and the proper Topological Cluster Centre (TCC) are created for each molecular graph, the ranking of the classes of topological key features and/or the ranking within each class of topological key features present in the TCC is used to generate a connected hierarchical Topological Sequence Path (TSP) of sentinel molecules from each molecular graph, and different molecular graphs and their Topological Sequence Paths (TSPs) share common vertices for common topological key features thus growing a Topological Structure Tree (TST), each chemical compound from the input stream is attached as a leaf node to the appropriate Largest Topological Substructure (LTS) node in the tree.

The invention concerns a new method for automatically and dynamically generating hierarchical topological trees of 2D- or 3D-structural formulas for structurally characterized chemical compounds, especially drug-like molecules. It supports structure-based information processing in many applications such as computer-based structure/property analysis, pharmacophore analysis, template-oriented Bayesian statistics for screening results in large-scale compound-repositories or structural analysis of patent compilations.

So far no automated dynamic procedure is available for an absolute and standardized structure analysis based on topological features for chemical compounds and drugs (Bayada D. M., Hamersma H. and van Geerestein V. J., Molecular Diversity and Representativity in Chemical Databases, J. Chem. Inf. Comput. Sci.,39, 1-10 (1999)).

Instead, methods for unsupervised learning such as clustering (Bratchell N., Cluster Analysis, Chemometrics and Intell. Lab. Systems, 6(1989), 105-125; Linusson A. Wold S. and Norden B., Fuzzy clustering of 627 alcohols, guided by a strategy for cluster analysis of chemical compounds for combinatorial chemistry, Chemometrics and Intelligent Lab. Systems, 44 (1998), 213-227) or supervised learning via various types of Artificial Neural Nets or structure-similarity-based methods such as maximum common substructure analysis (Holliday J. D. and Willett P., Using a genetic algorithm to identify common structural features in sets of ligands, J. Mol. Graphics and Modelling, 15, 221-232, 1997) are used to identify groups of similar compounds. Most of these methods rely on the paradigm that similar compounds do not only react and behave similarly but also have similar physical and biological properties. Consequently, these techniques require a measure for chemical similarity among compounds (Basak S. C., Bertelsen S. and Grunwald G. D., Application of Graph Theoretical Parameters in Quantifying Molecular Similarity and Structure-Activity Relationships, J. Chem. Inf. Comput. Sci., 1994, 34, 270-276; Basak S. C. Magnuson V. R., Niemi G. J. and Regal R. R., Determining Structural Similarity of Chemicals using graph theoretic indices, Discrete Applied Mathematics, 19 (1988), 17-44) which allows to score and compare calculated or measured chemical differences in compounds and group similar compounds together assuming that chemical distances among individual pairs of molecules do translate into appropriate differences of properties and activities for these compounds. Calculated similarities are often derived from limited sets of substructural elements (e.g. structural fingerprints) (Willett P., Chemical Similarity Searching, J. Chem. Inf. Comput. Sci., 1998, 38, 983-996; Flower D. R., On the properties of bit string-based measures of chemical similarity, J. Chem. Inf. Comput. Sci., 1998, 38, 379-386; McGregor M. J. and Muskal S. M, Pharmacophore Fingerprinting. 2. Application to Primary Library Design, J. Chem. Inf. Comp. Sci., 2000, 40, 117-125; Wild D. J. and Blankley C. J., Comparison of 2D Fingerprint Types and Hierarchy Level Selection. Methods for Structural Grouping using Ward's Clustering, J. Chem. Inf. Comput. Sci., 2000, 40, 155-162) in terms of a Tanimoto coefficient (Godden J. W., Xiu L. and Bajorath J., Combinatorial Preferences Affect Molecular Similarity/Diversity Calculations Using Binary Fingerprints and Tanimoto Coefficients, J. Chem. Inf. Comput. Sci., 2000, 40, 163-166). In principle, any available similarity criterion may serve for clustering by analyzing the similarity-ranked neighbour lists of each molecule in order to find those molecules that belong to the same cluster as any molecule pair in a cluster is characterized by the fact that each molecule has all other molecules in the cluster in its nearest neighbor list and vice versa.

The disadvantage of similarity-based procedures is that no absolute criterion exists for grouping the structures, instead a selfsimilarity test within the data set is applied for which each molecule must be compared with all others to find the closest neighbors. As the amount of data increases (e.g. more than a million of test compounds per screen), the effort spent for classification is at least quadratically dependent on the number of the molecules to be analyzed which often limits applicability of hierarchical classification methods (Mojena R., Hierarchichal Grouping Methods and Stopping Rules: An Evaluation, The Computer Journal, 20(4), 1975) to small data sets. Also due to new techniques such as combinatorial chemistry, the actual repositories of compounds increase and change their chemical properties with high speed. This renders any attempt for classifying compounds based on relative measures for selfsimilarity in the dataset an insufficient approach as the actual cluster membership varies due to the changes in the contents of the drug repositories. Moreover, the actual number of optimal clusters is not known in advance, requiring heuristic adjustment of parameters or a priori knowledge on the data. Nevertheless, one is often faced either with strange populations of some clusters or with existence of singletons for which no sufficiently similar compounds do exist.

Supervised Learning methods such as Artificial Neural Nets (ANN) require training (with the danger of overfitting data) and optimisation of net architecture. They are often used as “black box systems” providing results that may be difficult to understand. Thus, knowledge extraction on ligand and target properties from data may be limited and difficult to use for rational exploitation in subsequent ligand optimisation processes.

Known Maximum Common Substructure (MCS) algorithms suffer from the fact that they have to cope with the combinatorial explosion from pairwise structural comparisons in large data sets and will probably fail to be helpful for contadictory data in cellular multi-target assays. They may also fail to identify larger consensus substructures, if one to one correspondences among substructures are missing in structurally diverse datasets due to isofunctional or isosteric replacements in ligands.

In terms of template oriented procedures only techniques have been published so far that perform a predefined scaffold analysis in databases (Glenn J. Myatt, Wayne P. Johnson, Kevin P. Cross, and Paul E. Blower, Jr.; LeadScope: Software for Exploring Large Sets of Screening Data, Gulsevin Roberts, J. Chem. Inf. and Computer Sci. (2000), 40, 1302; WO00049539a1) based on a predefined hierarchy of 27,000 structural elements but without using any generic automatic or dynamic tool for structure and/or fragment analysis. For search of given compound profiles with known features, some progress has been achieved by similarity-based feature tree analysis (Rarey M and Stahl M, Similarity searching in large combinatorial chemistry spaces, J, Computer-Aided Mol. Design, 15, 497-520 (2001)) or shape similarity analysis (Andrew K M and Cramer R D, J. Med. Chem., 43, 1723 (2000)).

Yet, no efficient tools exist for standardizing the analysis and topological view on large scale drug repositories. However, this could facilitate chemistry driven information processing and support systematic identification and scoring of functional and topological gaps thus allowing to prioritize chemical substructure selection with synthetic considerations in mind. Often property-based techniques are applied and combined with statistical analysis for clusterering calculated or measured properties of available compounds in search for new chemical entities that fall into gaps of the property space (Linusson A., Gottfries J., and Lindgren F. and Wold S., Statistical Molecular Design of Building Blocks for Combinatorial Chemistry, J. Med. Chem. 2000, 43, 1320-1328; Pearlman R. S. and Smith K. M., Metric Validation and the Receptor-Relevant Subspace Concept, J. Chem. Inf. Comput. Sci. 1999, 39, 28-35) or in certain favourable property regions (Leach A. R., Green D. V. S., Hann M. M., Judd D. B. and Good A. C., Where are the GaPs? A Rational Approach to Monomer Acquisition and Selection, J. Chem. Inf. Comput. Sci., 40 (5) [2000], 1262-1269).

These methods, however, suffer from the fact, that desired properties for gaps may not easily be translated into amenable chemistry actually filling these gaps, partly due to the fact that either the desired properties are incompatible to that particular structure or the desired property profile is missed by the actual compound due to correlated or inaccurate parameters used for property estimation (Ward J. H. Jr., Hierarchichal Grouping to optimize an objective function, American Statistical Ass. Journal, 1963, 236-244.). In addition, all compound selections from property-based methods must consider the presence of the essential pharmacophore data to ensure the proper chemistry needed for drug-target interaction and bio-activity.

It is well known that 2D structures of compounds may be analyzed in terms of topological key features such as rings, linkers and sidechains (Bemis G W; Murcko M A, The Properties of Known Drugs. 1. Molecular Frameworks, J. Med. Chem, 39 (15) (1996), 2887-2893; Bemis G W; Murcko M A, Properties of known drugs. 2. Side chains, J. Med. Chem., 42 (25) (1999): 5095-5099) in order to summarize characteristic structural features of known drugs that might be transferable and relevant for new drug-like compounds. The definition of topological features has, however, only be used for retrospective database analysis of known drugs to demonstrate their frequency distribution in drugs. By using such topological features in molecular structures compounds may be categorized either by the number and types of these features in sort of a topological formula index (de Leut A., Hohenkamp J. J. J. and Wife R. L., Finding Drug Candidates in Virtual and Lost/Emerging Chemistry, J. Heterocyclic Chem., 37, 669 [2000]).

### Definitions

Graph: Mathematical construct built from nodes (vertices) and connected by edges. In this invention we will distinguish between two types of graphs, molecular graphs and trees.

Node (Vertex): End point of one or more edges in a graph or a tree representing a particular (chemical) object which may be visualized by a circle (or another symbol) or by a name tag (e.g. Line code, Topological Sequence Code (TSC) or MolCode). Depending on the object represented by the graph the physical interpretation of the node may change (i.e. nodes in molecular graphs represent atoms, nodes in

Topological Structure Trees are Compounds, (substructure) templates or molecular graphs in general).

Leaf node: End node in a tree, which in this invention will represent a fully exploded structural node for a chemical entity (and its molecular graph) present in the input data stream. Leaf nodes will be labeled by a unique registration id.

Edge: Connects two nodes in a molecular graph or in a tree (e.g. Topological Structure Tree (TST)) and will be visualized by a single or multiple line in a molecular graph and a single line in a tree.

Molecular graph: Model for the constitutional formula of a compound in which the nodes (vertices) represent atoms (characterized by type, number and valency), and the edges represent chemical bonds. Each compound is handled (and may be visualized) as an undirected, hydrogen-depleted molecular graph G(V, E)¹, where V(v₁,v₂, . . . ) is a set of vertices (nodes, atoms) and E(e₁,e₂, . . . ) is a set of edges (chemical bonds). For any compound i from the input data this graph will be abbreviated G(i). Vertices (atoms) in this graph may be any common non-hydrogen atom, where carbon is considered the virtual reference for drug like compounds. Edges (chemical bonds) may be of type single, double, triple, partially double/aromatic.

Template: All-carbon substructure built from basic topological components (ref. topological key features) such as rings, linkers or chains, which is mostly assumed to be a rigid and characteristic component of real drug molecule. A synonymous term is framework. The template (framework) is considered a sentinel molecule for collecting all chemical derivatives of that topological type, thus comprising various classes of chemical derivatives, that either may be theoretically possible or actually present in the input data stream.

Scaffold: Similar to a template but chemically modified (i.e. by existence of heteroatoms). Thus it may represent not only a rigid frame, but also a specific and well-defined geometric and functional motif for ligand target interaction.

Core: Highest ranked topological element (all-carbon substructure) present in a real drug that serves as the root node in a Topological Structure Tree.

MolCode: Characteristic name tag for any substructural node present in a Topological Structure Tree (TST). It may consist of two parts: 1^{st} a topological name tag that is defined as a hierarchically organized text string (i.e. a line code) from predefined labels for the constitutive topological key features present in the molecular graph (such that it may be easily translated back into the original template structure) and 2^{nd} a chemical modifier string attached to the line code that specifies the position and type of chemical transformation for each substructure element that has been chemically transformed. The term MolCode will subsequently be used for all name tags of (sub)structures regardless of the fact that the structure is an all crabon template (which only requires topological data for characterisation) or a chemical derivative. If the MolCode is generated for the largest all carbon substructure (i.e. the Topological Cluster Centre) it may be interpreted also as a Topological Sequence Code (TSC) for all valid substructures included. For the actual compounds from the input stream no MolCode will be assigned but the original registration number will be used as a name tag instead

Tree: An assembly of edge-linked nodes in which no cicular path is present. The meaning of the nodes (vertices) and edges depends on the objects represented by the tree (e.g. TSTs are constructed from molecules and substructure templates of varying complexity). In this invention dynamic trees are used for constructing hierarchical Topology Structure Trees from large volume input streams on the fly and visualizing the trees as well as the compounds under flexible user control.

Topological Class: A substructure category (or class) that may be present in a given compound and characterized by the property that some atoms form a ring (R), a linker (L), chain (C) or any valid combination thereof. By definition the reference topology classes are carbon-only templates, which are expected to show no specific intrinsic bio-activity by definition. In addition to their types, these topology classes will be characterized (and scored) by heuristic criteria that are rule-defined for all topological key features used. Each topological class may be sub-divided into sub-classes according to size (or length), atom valency (or degree of saturation, e.g. aromatic, aliphatic etc.) or number and type of functional modification (e.g. number of heteroatoms, Don-/Acc-properties, positive/negative charges, acidic/basic groups etc.).

Topological key features: Structural (i.e. topological) and chemical features present in molecules that either define a topological class (i.e. rings, linkers or chains) or introduce a chemical modification to the all carbon topological reference template such as heteroatoms and/or substituents that affect prioritisation of that particular substructure element.

### Categories of Topological Key Features

Ring (R): Within each molecular graph G any existing ring forms a cyclic subgraph characterized by the length of the Hamiltonian path for that substructure (e.g. number of ring atoms or ring size, r=3,4,5, . . . ).

Linker (L): Acyclic linear or branched chain of length l (l=0,1,2,3, . . . number of bonds in the linker skeleton) present in the molecular graph which by definition starts and ends at vertices belonging to at least two different rings (or more, for branched linkers).

Substituent (S): Non-cyclic attachment of overall size s (s is the number of atoms in the substituent), which is known as a chemical functional group (e.g. halogens, amino-, carboxyl-, hydroxy-, sulfonamido groups, aliphatic chains etc.) attached either to rings, linkers or chains present in the molecular graph. Substituents may be seen as special instances for heteroatom-substituted chains.

Chains (C): Linear or branched non-cyclic substructures of length c (c is the number of atoms in the chain), that are joined neither to a linker nor to a single ring vertex in the molecular graph. Acyclic carbon skeletons, that are attached to a ring or to a linker, will be handled as aliphatic substituents.

Heteroatoms (H): All Carbon-replacements present in rings, linkers or chains of the molecular graph. However, Heteroatoms do not only differ from Carbon in their topology (number of bonds and spatial geometry), but also in their electronic properties (electron lone pairs or electronic gaps) thus affecting basicity/acidity, hydrogen bonding, solubility, chemical reactivity and bioactivity (target binding, pharmacokinetic properties, toxic properties etc.). Thus, heteroatoms may be subdivided for chemical reasons according to their properties into different sub-classes (HB Don-/Acc, Acidic/basic, negatively/neutral/positively charged atoms etc.) affecting each topological subclass individually.

Topological Sequence Code (TSC): Hierarchically organized Line code built from the topology key features present in the molecular graph. It is characteristic for a particular topology and its Topological Cluster Centre (TCC) reflecting type, priority and linkage of substructure elements in the original compound in standardized form. The TSC is constructed from the Topological Cluster Centre CCC) of each compound by applying a heuristic expert rule-system that prioritizes the topology elements present. Thus, it allows to create priority shells of growing substructure size around the top-ranked central core fragment in a molecule which are properly reflected in the line code sequence (i.e. the MolCode or TSC) for the TCC. Substructures for the individual priority shells of the TSC may be handled as individual sentinel templates characteristic for the parent compound they have been derived from (see TSP). The TSC is the topological part of the actual MolCode string.

Topological Sequence Path (TSP): Connected sequence path of prioritized substructure templates in the TST that is created from the TCC by partitioning the TSC into individual substructure shells that are handled as additional virtual reference molecules (or independent sentinel templates) in the TST. Due to their coexistence in at least one TCC these virtual tree nodes are connected by edges that reflect close neighbourship in real existing compounds present in the input stream.

Largest Topological Substructure (LTS): Residual part of a molecule, that is left after eliminating all substituents in a molecule. It is placed beyond the TCC in the TST. The actual compound structure is attached to the LTS as a tree leaf node representative for that particular chemical derivative of the LTS or TCC node.

Topological Cluster Centre: All-carbon equivalent to the Largest Topological Substructure (LTS). Generated from the LTS graph by morphing all heteroatom nodes in the molecular graph to carbon atoms without changing the priority of the substructure elements.

### General Description of the Invention

The invention is based on a new graph-based method for automatic computer-based 2D/3D structure analysis in large amounts of compounds. It uses topological key features (substructure elements) for generating representative (virtual) substructure templates and arranging these in collections of dynamic trees (i.e Topological Structure Forests (TSFs) and Topological Structure Trees (TSTs), see below). This is achieved by using these sentinel templates as topological reference structures that monitor all sort of chemical transformations present in that substructure type in the input data set by attaching the derivatives to the appropriate ancestor nodes in the tree. That way the problem of having an unknown number of clusters for which representative structures must be found by selfsimilarity analysis is avoided by construction.

The invention concerns a method for automatically generating, analyzing, grouping and visualizing all topologically unique chemical templates and their derivatives present in the molecular graphs for the input data by mapping specific topological classes and templates on the nodes of dynamic trees and typifying their substructures by a rule-based system for generating a hierarchically prioritized topological line code for templates. Due to graph techniques used and the definition of topological criteria combined with heuristic rules for scoring topological classes very efficient data processing for chemical typification, topological categorisation and property classification may be achieved for large volume input data (i.e. from HTS or UHTS). This is realized by applying an algorithm for simplifying the molecular graph of a molecule to a representative simple graph for the largest carbon-only substructure, which contains all topological key features sufficient for characterizing the original molecule. This substructure is called the Topological Cluster Centre (TCC). It is characterized and labeled by the Topological Sequence Code (TSC), that actually encodes and concatenates prioritized strings, which label smaller topological substructure elements contained in the TCC template by a simple hierarchical topological line code mounted from substructure labels in decreasing priority of the topological key features present in the original molecule.

Once, the TSC for the TCC has been generated, the constitutive topological subsets (shells) are mapped on a sequence of (growing) substructure nodes that form a Topological Sequence Path (TSP) or a TST in general. By sequentially exploding the priority shells for the topological substructures around the core structure contained in the TSC the Topological Sequence Path (TSP) is generated and its components are visualized as a consecutive sequence of new substructure nodes in a simple connected sub-tree or tree fragment. It starts with the highest prioritized substructure (TSP-root node at top of the tree) and ends with the TCC template beyond which the original compound will be placed as a tree leaf node. The TSP tree nodes are characterized both by the specific all-carbon substructure as regular molecular graphs (i.e. molecules) and by the associated MolCode with respect to the hierarchical order of the substructure elements assigned from the topological prioritisation scheme. Each of these all carbon frameworks may itself serve as a (virtual) sentinel or anchor node to which two types of information may be attached—closest chemical derivatives may be linked as scaffold nodes or compound leaf nodes while information tags including target information and statistical data for activity in assays may be attached for monitoring activity or property profiles for template assessment in biological testing.

The TSP itself may be embedded in a larger hierarchical Topological Structure Tree (TST), that is grown from the TSP, or may be member of a forest of such trees (Topological Structure Forest (TSF)) which spanns all input molecules as well as all substructure nodes derived from the molecules. The tree nodes (structures) are linked by edges, which indicate paths of varying substructure size in the corresponding TST-nodes when traversing top down in the TST (or vice versa).

Branching of the tree will be caused by existence of compounds, that share topological features in their TSPs, while linking in general will be based on topological ranking for nodes (substructures) along their TSPs following a heuristic rule-based scheme for inter-class and intra-class prioritization of topological key features.

As an important feature of the tree each intact molecule structure is attached (together with ist LTS) beyond that TCC node, that represents the largest all-carbon substructure of the compound. Thus, the TCCs and all sentinel templates along the TSPs dynamically collect and represent all chemical derivatives for all topological substructures present in the input data. The nodes of the TSPs serve as additional representative management (or sentinel) molecules for chemical modifications in their appropriate substructures which also allow for branching of the tree.

The practical generation of the hierarchical Topological Structure Tree (TST) is controlled by sequentially and recursively applying a set of heuristic rules for scoring the modifications (i.e. number of heteroatoms, number of substituents, size, degree of saturation etc.) in structural topological classes built from rings, linkers and chains. Inter-class prioritization between substructure elements is achieved first, while creating the TCC, and in the second step the sequence for further partitioning the TCC into smaller representative substructures (along the TSP) is found. As each compound processed generates such a TCC and a corresponding TSP, the Line codes may be used to check by boolean operations if topological substructures may be shared in subtrees beyond their root nodes. Depending on the uniqueness of the core (root node) and the data for the intersection sets, either new TSPs will be created or new nodes will be attached to existing ones such that the new non-overlapping parts of the TSPs are linked to the actual TST.

Thus, for prefiltered active and inactive chemical compounds from a particular assay standardized TSTs/TSFs may be generated and compared by boolean operations based on equivalent TSP-sets such that they may serve as starting points for creating machine-based hypotheses for the effect of templates and their chemical modifications on target activity/specificity.

Also monitoring the effect on bio-activity for heteroatom substitution or for substituents present in templates, scaffolds, rings, linkers and/or chains may be supported by appropriate coloring of graph nodes, as to identify framework and fragment-based structure/property and structure/activity relationships actually needed for synthesis planning in lead optimisation projects.

Thus, structural information for large scale amounts of chemical compounds may be processed fast and in a way enabling identification, visualization and grouping of all topologically unique scaffolds for subsequent analysis of largest common substructures, accessible structural templates, R-group deconvolution for templates and pharmacophore perception. Due to favourable properties of the algorithm it is well-suited for many practical aspects and tasks involved in structure-property based chemical information processing in general, some of which will be mentioned below.

The algorithm can be implemented as a fast standardized graphical front-end that may assist in all types of structure- and property-based information processing on organic chemical compounds in course of lead structure identification based on simultaneous Structure Activity Relationships (SARs) for all templates at a time, calculation of substructure-related hit probabilities for template prioritization, identification of unoccupied structural or functional chemical spaces present in the compound repositories or in screening pools for (HTS-) runs.

Also, instead of feeding single assay results for analysis, overall HTS archives or structures from active compounds' screening history may be processed in search for privileged or promiscuous templates for which an evaluation of the template-related likelihood for activity or specificity is needed.

Identification of topological gaps or missing chemical derivatives is also possible as for each all-carbon template of a topological class all available compounds in the repository are automatically included in the TST. The molecular graphs resulting from any possible modification in the topological key features in any ancestor node in the TST that lead to new compounds not yet present as specific leaves at the bottom of the TST are identified as topological and/or functional gaps by construction.

Similarly, the procedure may be used for simultaneous R-group deconvolution on all substructures. Comparative topological classification of available databases with respect to topological features present in endogenous substances (bio-effectors) and in actual screening hits may give hints to possible biological targets addressed by cellular HTS runs.

Also structure- and test-based information from competitor patents or from publications may be used for SAR analysis and framework prioritization. Commercially available substances and synthones analyzed by these techniques may be used for identifying the most versatile candidates for filling the topological and electronic gaps present in the drug despositories or in combinatorial libraries.

### DETAILED DESCRIPTION OF THE INVENTION

In the following it will be referred to

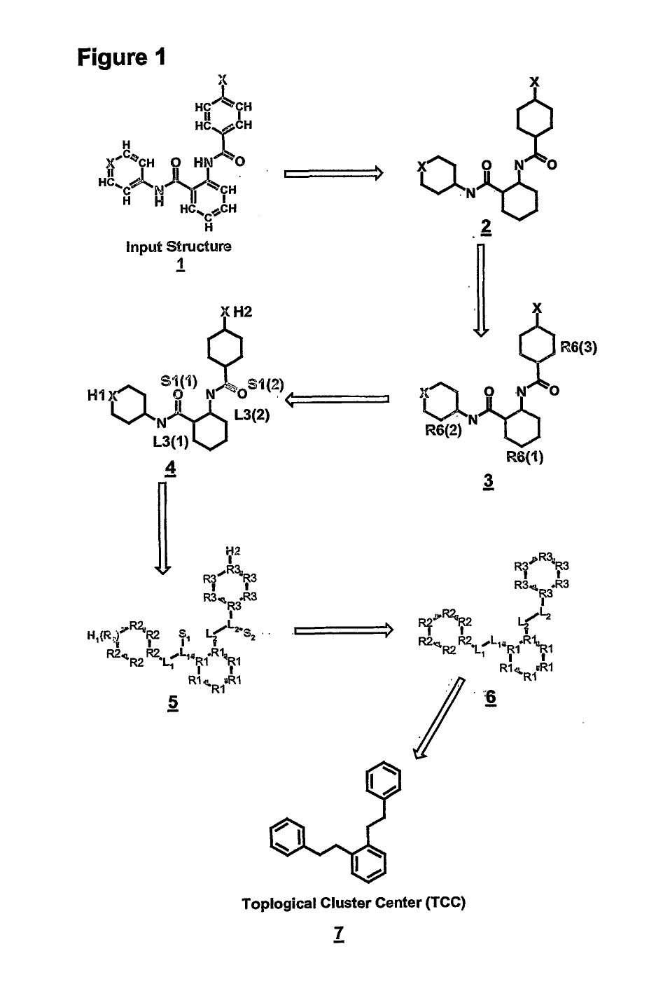

FIG. 1 Selected steps and intermediate results for generating the Topological Cluster Center (TCC) from a 2D-molecular graph

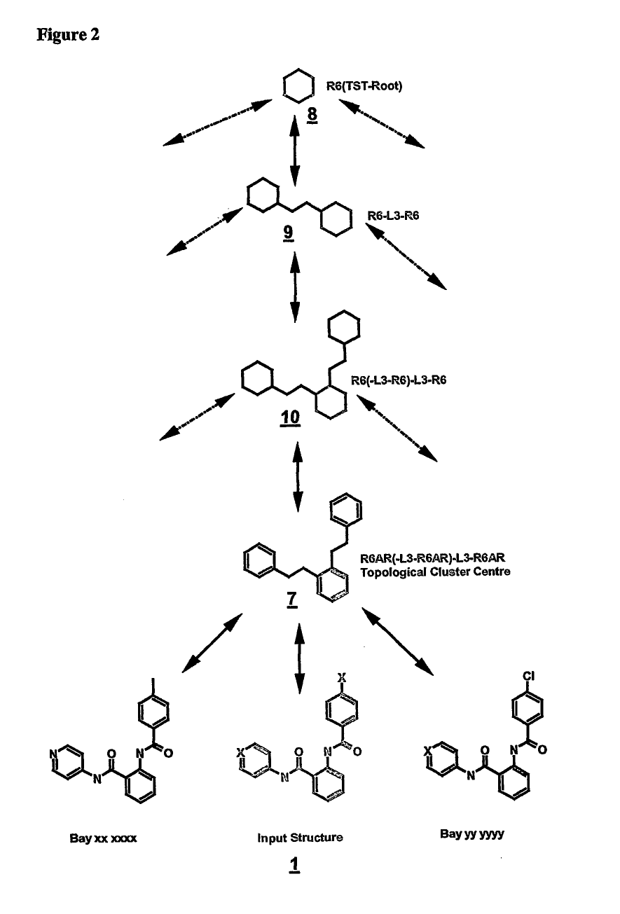

FIG. 2 Example for generating the Topological Sequence Path (TSP) between root node (core) and TCC and use of the Topological Sequence Code (TSC) as name tags. The TCC (and each other TSP-node) are used as representative reference structures (virtual sentinel templates which are most likely void of biological activity) for collecting and grouping chemical derivatives of closest topological proximity.

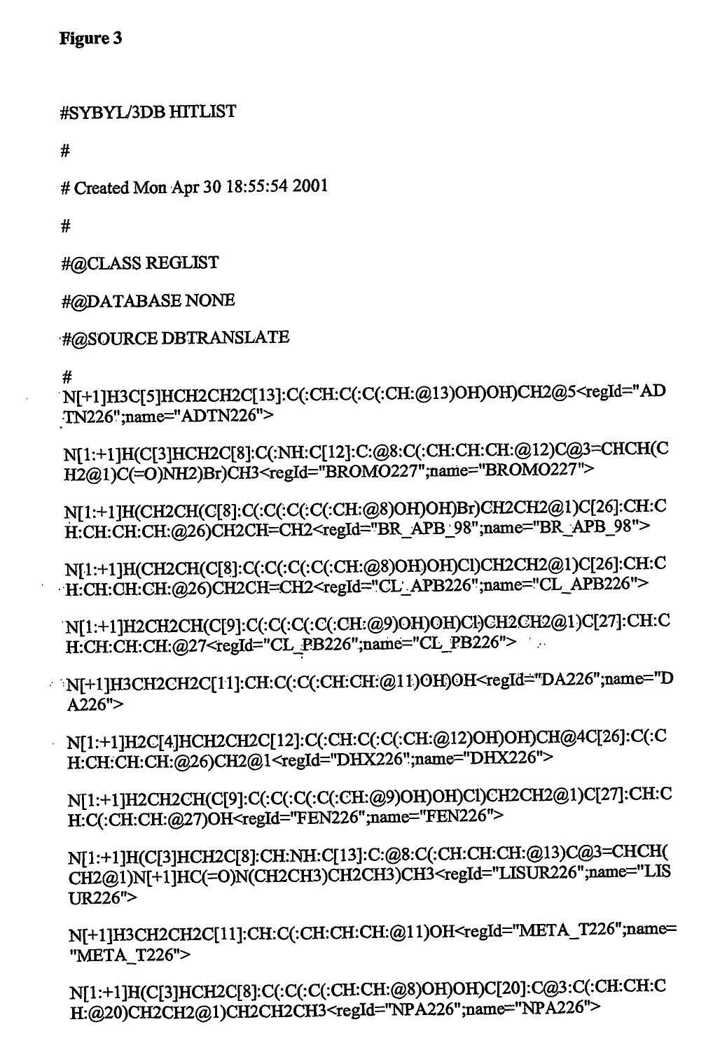

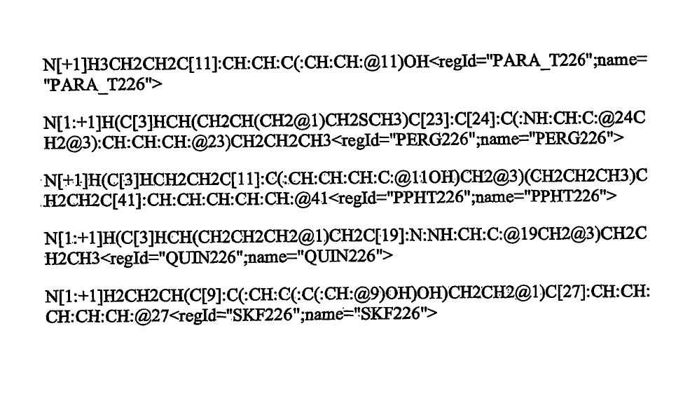

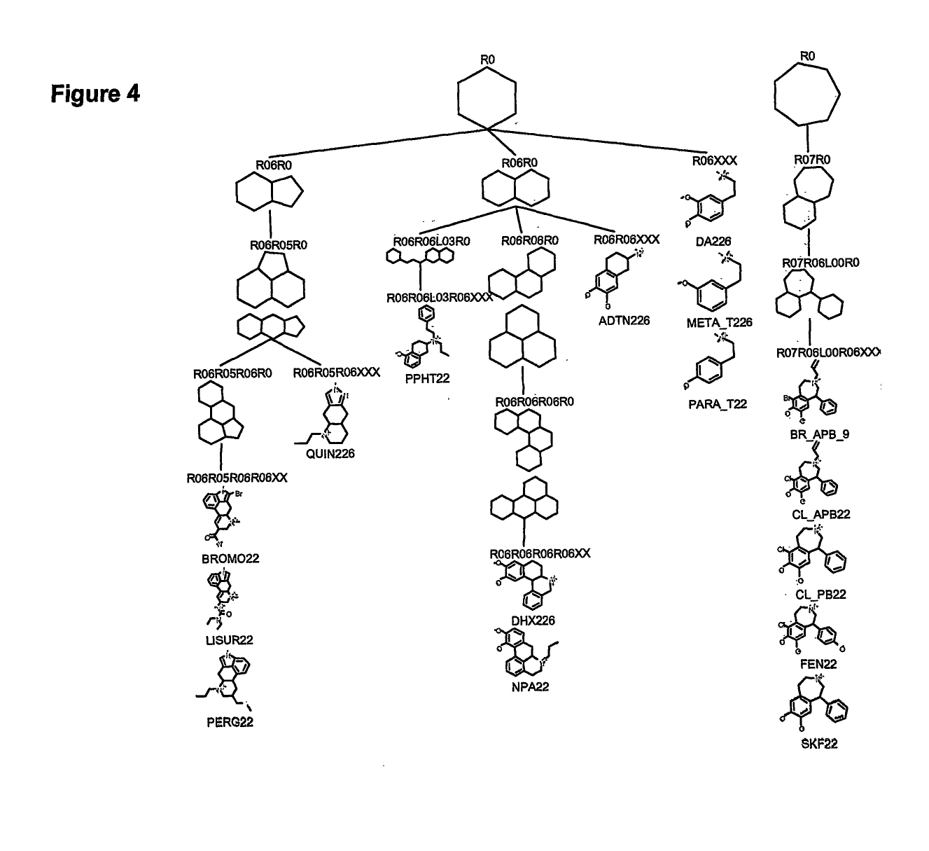

FIG. 3 Input data (Sybyl Line Notation (SLN)) for a small set of 2D structures (dopamine D1/D2-agonists taken from literature). This dataset has been used to produce FIG. 4 with an in-house computer-program, which is based on the invention described herein.

FIG. 4 Example for a computer-generated TST of dopamine D1/D2 agonists from literature. The results have been generated by using an in-house computer-program, which is based on the invention described herein.

The methods according to the claims are applied to input data for molecules, that contain all relevant information needed for generating the basic molecular graphs (e.g. input data should be supplied as Sybyl Mol2 files, MDL Mol files, smiles format or SLN etc.)

Proper choice of input data is achieved by applying appropriate prefilters for target properties, that facilitate interpretation and focus results to solutions for special tasks.

Selection of filter for:

Active substances in a particular screening assay for Hit analysis in terms of structural determinants for activity or for hit statistics.

Inactive substances in a particular screening assay to assess candidates and their likelihood estimates both for false positives and ˜negatives in various substructure classes.

All active compounds in the screening history for bio-profiling of the drug repository and search for privileged or promiscuous templates.

All compounds of the whole drug repository or subsets thereof for drug repository profiling, gap analysis, template-oriented R-group deconvolution, compound synthesis and compound purchase.

Competitor (patent) structure/activity data for identifying patent gaps and inhouse knowledge exploration.

Endogenous (active) compounds (bio-effectors) or active metabolites for indirect target classification.

Natural (active) drugs for unusual scaffolds, SAR analysis and template selection.

### Structural Representation of Molecules

Each compound (i.e. compound 1 in FIG. 1) is handled as an undirected, hydrogen-depleted molecular graph G(V, E)², where V(v₁,v₂, . . . ) is a set of vertices (i.e. atoms) and E(e₁,e₂, . . . ) is a set of edges (i.e. chemical bonds). For any compound i from the input data this graph will be abbreviated G(i). Each compound's graph may be partitioned into subgraph elements, which are defined either in terms of topological classes T={R,L,S,C} due to their connectivity properties as topological templates such as rings (R), linkers (L), substituents (S) and chains (C) or as modulators for atomic properties e.g. heteroatoms H={vᵢ # Carbon}, that affect physical and chemical properties (e.g. solubility and reactivity) and thus via chemical affinity towards biological targets also the template's importance for new drug candidates. The ring and linker classes may be used to create new topological classes of compounds or substructures for any valid and unique combination Rₓ L_{y} R_{z} of ring and linker types present in any particular compound (i.e. R₅ is the subclass of five-membered ring compounds, R₆-L₂-R₆ is a subset characterized by the presence of a linker of length two joining two six-membered rings etc.). The same procedure may be applied within the chain class. For tasks in later phases of data analysis, such as pharmacophore perception, some of the sets (S,H), require partitioning in further subsets, that allow to characterize functionality for target and/or solvent interaction (i.e. by partitioning in hydrogen bond donors D or acceptors A) or ionizable groups, that arise from Broensted acids I_{A} or ˜bases I_{B} present in the molecule or partitioning in polarized charged groups (i.e positive, neutral or negative charged atoms). For QSAR, QSPR or significance analysis of the structural features in compounds their graphs may require transformation into equivalent Line Graphs (Estrada E., Generalized Spectral Moments of Iterated Line Graphs Sequence. A Novel Approach to QSPR Studies, J. Chem. Inf. Comput. Sci., 39 (1), 90-95 (1999)).

### Definition of Key Topological Class Elements

Within G any existing ring forms a cyclic subgraph characterized by the length of the Hamiltonian path for that substructure (e.g. number of ring atoms or ring size, r=3,4,5, . . . ). All rings for that compound form subclasses (sets) Rᵣ which are defined by the size r of the rings present in the molecule, but may be different in priority according to the scoring scheme (i.e. highly substituted rings are higher ranked than mono-substituted rings of the same size). Special cases that may need further consideration for ring classification are spiro compounds, labeled as RₘRₙ and annulated ring systems, Rₘ:Rₙ, respectively, as both could have also be classified as special cases for linker systems which, however, start and end at the same (for spiro cmpds) or at neighboured vertices (for annulated rings) of the same ring system (see below).

A linker is an acyclic linear or branched chain of length l (l=0,1,2,3, . . . number of bonds in the linker skeleton), which by definition starts and ends at vertices belonging to at least two different rings or more (for branched linkers). All linker types are collected in the linker set L, whose members will differ in priority (according to degree of substitution by heteroatoms and substituents, priority of attached rings and linker length). Linker length l=1 is considered a special case for joined rings (e.g. biphenyls have a single bond between rings, but the number of linker atoms is zero, hence, the TSC for biphenyl substructures is R₆-L₁-R₆).

Any substituent is a non-cyclic attachment of overall size s (s is the number of atoms in the substituent), which is known as a chemical functional group (e.g. halogens, amino-, carboxyl-, hydroxy-, sulfonamido groups, aliphatic chains etc.) attached either to rings, linkers or chains. All substituents are collected in the substituent set S, which may differ in priority for individual set members using calculated or measured properties for charges, acidity PKₐ, basicity pK_{b}, size (i.e. number of atoms) etc.

Chains are linear or branched non-cyclic substructures of length c (c is the number of atoms in the chain), that are joined neither to a linker nor to a single ring vertex. Acyclic carbon skeletons, that are attached to a ring or to a linker, will be handled as aliphatic substituents. All chains are collected in the chain set C, which is ordered according to chain priority based on degree of substitution, size etc.

The set of Heteroatoms H is defined by all Carbon-replacements in rings, linkers or chains of the molecule, which may also introduce differences in connectivity relative to the topologically equivalent All-Carbon-framework considered as the virtual “Topological Cluster Centre” (TCC) for each particular scaffold. However, Heteroatoms do not only differ from Carbon in their topology (number of bonds and spatial geometry), but also in their electronic properties (electron lone pairs or electronic gaps) affecting basicity/acidity, hydrogen bonding, solubility, chemical reactivity and bioactivity (in vitro activity, pharmacokinetic properties, toxic properties etc.). Thus, heteroatoms may be subdivided according to their properties into different sub-classes (Acidic/basic, negatively/neutral/positively charged substituents etc.) affecting each topological subclass individually. Therefore, they may serve for prioritising the relative importance of the rings, linkers, substituents and chains in the topological representation of the dataset to be analyzed.

By use of these definitions any structural element in a compound may be classified systematically. Hence, any chemical compound may be characterized by all its topological key features either in the form of a Topological Class Index (TCI), which summarizes the number of topological key features of each type present in the molecule structure, or, more precisely, as an easily interpretable prioritized sequence of linked topological class elements e.g. a Topological Sequence Code (TSC). By definition this TSC represents a (virtual) Topological Cluster (Class) Centre (TCC) for an All-Carbon-framework of closest topological proximity to the actual functionalized compound and any substructure derived from that. The TCC serves as a generic parent (or ancestor) node for all chemical modifications in this scaffold. It also serves for bundling all topologically similar compounds and as a reference structure for defining the topological subspace available for chemical derivatives from which available species may be subtracted to yield the topological and functional gaps actually present in the dataset.

All unique TCCs generated from the input data may be considered either part of a common hierarchical Topological Structure Tree (TST), if they share topological key features in their molecular structure, and hence in their TSCs, or as a collection of TSTs (a Topological Structure Forest (TSF)) if the intersecting set of topological key features in the TSCs is empty.

A procedure is described, which applies a rule based scoring scheme for generating the TCC for each compound by ranking available topological key features of the molecule and assigning a topological sequence line code (TSC). This TSC is then used to sequentially construct a sequence of growing substructural parts from the TCC, starting from the highest ranked topological class element (fragment) (the TST root node or core) and ending with the TCC. Each of these substructures is labeled by its own (fragment) TSC, which is a prioritized sequence of connected topological key features forming a valid sequence of growing substructure nodes between the TST root node and the terminal TCC node beyond which chemical structures with a unique chemical modification of the TCC will be placed as terminal TST leaves carrying all detail information for that compound. The completely connected sequence of substructure nodes generated that way forms a Topological Sequence Path (TSP) as an initial set of connected sentinel structure nodes for growing a TST.

For any new compound it will be checked if its Topological Sequence Path (TSP) shares any features with TSPs from other compounds. If a proper root node does not yet exist at the time of structural analysis of the compound it will be created as a complete topological path as described before while intersecting parts with existing TSTs will be used for linkage of the nonoverlapping structural elements otherwise. The final set (forest) of TSTs generated from the input data allows to analyze huge amount of data with respect to the topological criteria applied in the rule-based system for scoring substructure elements at various levels of detail thus reflecting and monitoring the hierarchical structure evolution of topological features required as structural determinants in target modulators.

As the ordering and ranking for the TSTs is both strict, but also modifiable through the sequence and contents of the rules to be applied a flexible structure-based system (i.e. a dynamic forest) is created for which the lay-out may be customized to the needs of the user such that he can easily navigate through the TSTs in search for the most convenient templates for his favoured synthesis routes, available synthons etc.

In order to make this strategy operational, the following items are necessary:

a sequence describing the overall operating procedure for the computational subparts

techniques for identifying the topological key features in a molecule

rules for scoring different topological key features relative to each other (inter class scoring)

rules for intra-class scoring of topological key features

an algorithm for creating the TCC

a technique for creating the Topological Sequence Path (TSP) from a TCC for a given compound.

techniques for labelling of TST nodes and (sub)structures by (fragment) Topological Sequence Codes (TSC)

rules for creating and linking nodes (Topological Sequence Paths (TSP)) in a TST

techniques for structural, statistical and biological analysis of TSTs (according to the targetted input data)

techniques for storage and retrieval of topologically analyzed data sets

techniques for subtree scoring and structuring beyond the TCC-node level

### An Overall Data Processing Work Flow

The overall procedure for structure-based analysis of large scale data sets (now globally termed input data) proceeds in several steps (ref to FIG. 1):

I. Sequential input of a prefiltered molecular structure and generation of its hydrogen depleted molecular graph for further analysis.

II. Identify and label the classes and subclasses of topological key features present in the molecular graph.

III. Perform intra-class prioritization for all topological classes and label the vertices in the molecular graph appropriately.

IV. Eliminate all substituents in the molecular graph (create the LTS) and evaluate the functional degree of the topological subclasses present in the molecular graph.

V. Generate the Topological Cluster Center (TCC) framework and label it by its Topological Sequence Code (TSC). Link LTS to TCC.

VI. Link the actual molecular graph for the input structure to the LTS (e.g. as part of a growing multiply linked list with TCC and all TSP nodes).

VII. Establish a Topological Sequence Path (TSP) between the highest ranked topological substructure in the molecular graph (TSP-root) and the TCC, which is considered part of a global Topological Structure Tree (TST) for the input data. Check existence of an appropriate TST, if available mount the unique parts of the compound's TSP to the existing TST, otherwise insert the new TSP in the existing data structure.

VIII. Update special storage fields (e.g. for screening statistics, bio-profiles, subtree population) attached to the actual TCC (e.g. the ancestor node for each compound in the TST) and to each substructure node (e.g. for the statistics of the attached child nodes).

IX. If the number of structural leaves (e.g. compounds) beyond the TCC or the LTS exceeds a predefined critical number, a horizontal ordering at that level of detail may be achieved by calculating appropriate graph invariant features for each compound which may be used for sorting and ranking the structures based on an accurate metric such as the Mahalanobis distance.

X. Proceed with I. for next compound (as long as new compounds are available).

XI. Do post-processing for selected (or all) TCCs and all their subtrees for statistical analysis, hit validation, pharmacophore perception, or in search for framework gaps and/or gaps in chemical derivatives.

XII. Store the resulting forest of TSTs on disk replacing the structural data for the compound leaves by the compound registration code (e.g. Bay number) using state of the art techniques for the arrangement and the processing of the available TSC data.

Subsequently some process steps will be described in further detail.

### Determination of the Topological Subclasses in the Molecular Graph

For any compound and its associated graph G the topological class elements may be determined algorithmically due to the fact that only ring elements are start and end points for self returning walks in a graph (Bemis G W; Murcko M A, The Properties of Known Drugs. 1. Molecular Frameworks, J. Med. Chem , 39 (15) (1996), 2887-2893). All paths of the molecular graph will be analyzed and visited vertices may be marked by atom labels. All paths not ending in rings or not being part of rings will be clipped, while the numbers of substituents in each instance of a topological class from R, L, C will be counted and stored for use in the scoring process.

In the following description algorithms are formally mimicked by use of equivalent mathematical operators, which transform operands (proper input data, i.e. graphs or substructures) into the required results (i.e. forests, trees, substructures, lists, scores etc.) as algorithms or programs would do.

A general topological operator \hat{T} is defined representing a collection of operators {\hat{R}, \hat{L}, Ĥ, Ŝ, ĉ}, one for each topological key feature, which, when applied recursively k-times to a molecular Graph G(i) or a subgraph of G(i), generates the proper atom sets or subgraphs for the appropriate topological class of rank k, labeled Tₖ, in the general case k=1,2 . . . ). In a given compound containing r rings and 1 linkers r-fold repetition of \hat{R} (i.e. \hat{R}^{r}) and 1-fold application of \hat{L} (i.e. \hat{L}^{l}) generates the complete sets of rings R and linkers L. If no rings or linkers are present in the molecule empty sets will be generated. In particular it holds.

G(i)=_{\hat{T}}⁰(G(i))

Tₖ(i)=_{\hat{T}}^{k}(G(i))

$$\begin{matrix}R ( i ) = {⋃}_{k = 1}^{r} {\hat{R}}^{k} ( G ( i ) ) \\ L ( i ) = {⋃}_{k = 1}^{l} {\hat{L}}^{k} ( G ( i ) ) \\ H ( i ) = {⋃}_{k = 1}^{h} {H}^{k} ( G ( i ) ) \\ S ( i ) := {⋃}_{k = 1}^{s} {\hat{S}}^{k} ( G ( i ) ) = ( ( G ( i ) \backslash R ( i ) ) \backslash L ( i ) ) \backslash C ( i ) \\ C ( i ) := {⋃}_{k = 1}^{c} {\hat{C}}^{k} ( G ( i ) ) = ( ( G ( i ) \backslash R ( i ) ) \backslash L ( i ) ) \backslash S ( i )\end{matrix}$$

G(i)={vₖ|∈ V, vₖ∈R(i) [symbol] vₖ ∈ L(i) [symbol] vₖ ∈ S(i) [symbol] vₖ ∈ C(i)}

Thus, recursive and exhaustive application of the topological operators creates a valid decomposition for the hydrogen depleted molecular graph into all sets of topological classes used: Rings, linkers, heteroatoms, substituents, and chains. These classes are used for the automatic generation of sets of representative topological substructures, that are assembled to form dynamic hierarchical trees based on prioritization rules for topology classes.

### Possible Ranking for Classes of Topological Key Features Relative to Each Other

For the classes of topological key features a heuristic rule-based prioritization scheme is defined by the following scoring (in decreasing order of importance), which is applied sequentially top down and as needed for any particular compound (ref. to FIG. 1):

(1) Rings

(2) Linkers

(3) Heteroatoms

(4) Substituents

(5) Chains

This choice for prioritization scheme is based on estimates for the significance to interpret the observed effect for a specific type of chemical modification over all topological classes (rings, linkers, chains) of same size, considering the fact that conformational flexibility of the template and the 3D-spatial conformation of the ligand models has been ignored so far.

From this definition for the topological classes it follows that the topological root node (the highest ranked topological class element) for any given molecule may be either a ring system or a chain, in case of a strictly acycylic compound. As the definition of a linker is coupled to the existence of terminal rings, scoring for linkers is also coupled to ring priorities.

### Possible Ranking within Topological Classes

Within the topological classes rings, linkers and chains a natural rank order may be determined by applying the same sequence of scoring rules (in decreasing order of priority, ref. to FIG. 1), which is illustrated by the following sequence of criteria:

a) Degree of substitution in the topological subclass/substructure (e.g. number of heteroatoms and substituents in rings, linkers or chains). Annulated rings are considered special cases of ring substitution, which may be identified by the existence of multiple self return walks starting from vertices along the Hamiltonian path of the ring substructure or by analysis of the smallest set of smallest rings (SSSR, see also Petitjean J., Tao Fan B. and Doucet J -P, J. Chem. Inf. Comput.. Sci., 2000, 40, 1015-1017; and Lipkus A H, Exploring Chemical Rings in a Simple Topological-Descriptor Space, J. Chem. Inf. Comput. Sci, 2001, 41, 430-438).

b) Number of vertices (atoms) present in the topological subclass or subgraph. For (branched) linkers priority is sequentially assigned to all possible paths strictly for decreasing rank of terminating rings (starting with the highest one), decreasing degree of substitution and increasing path length. Rings joined by a single bond may be classified by a linker length of one by definition (refer to biphenyl example above). Shortest paths/smallest ring size have highest priority next to degree of substitution. In cases of non-unique scoring for equal linker length the linker joining the higher prioritized rings will be favoured in ranking. If this still non-unique the higher substituted linker will be preferred.

c) For equal degree of substitution and length of linkers/size of substituents/lengths of chains ranking is derived from the substituent type prioritization scheme (1) to (5), described before: Substitution by linkers is higher in priority than heteroatoms and substituents (in decreasing order of priority). If still non-unique scores have been found at this level of categorization probably local chemical identity or constitutional isomers have been identified in which case the sum of the path distances to the substituent positions along the shortest path segment of the ring may be used in search for differences.

d) For all points a) to c) being equal, the degree of saturation within the topological subclass is considered: in particular, aromatic (fully unsaturated) rings have highest priority and may be labeled specifically by attaching the suffix “Ar” to the ring label string or the number of unsaturated bonds may be added to the name tag for the fragment (ring, linker or chain). Partially or fully saturated ring systems have lower priority due to greater spatial complexity and possible existence of chirality centres. Unsaturated linkers and chains are handled similarly for consistency.

e) Alternatively, a more quantitative ranking order may be achieved based on some calculated graph invariants (Todeschini R. and Consonni V. in: Handbook of Molecular Descriptors, Methods and Principles in Medicinal Chemistry Vol. 11, Mannhold R., Kubinyi H. and Timmerman H. (Edts), Wiley-VCH, 2000, i.e. spectral moments) either for compounds to support Discriminant Analysis (or equivalent classification methods) for training and test data selection in the final analysis phase for the TCC subtrees.

The process of generating and ranking topological scaffolds by a general function which applies rules (1)-(5) and a)-d) to some arbitrary molecular graph is illustrated in Example 1 (FIG. 1).

### Identification of the Topological Cluster (Class) Centre (TCC)

Once all topological classes have been identified in a molecule and the above mentioned prioritization scheme has been applied recursively for each topological class the vertices (atoms) in each subclass of the clipped molecular graph are labeled and characterized by class, intra-class scoring and property information (e.g. R₅(1) means five membered ring, highest (#1) priority of all rings present in the molecule, L₄(2) says there is a linker of length four (i.e. four bonds and three atoms long) and priority two, ref. to FIG. 1).

As the clipped molecular graph still may contain heteroatoms in rings, linkers and chains, these will be morphed to carbon atoms in order to generate the required TCC graph (ref. to FIG. 1), which serves as the reference topology for all derivatives of that type. For this process we define a carbon-morphing operator \hat{M}_{T}_{ₖ}_{,p}(Cₚ) as a special case for a general chemical atom (Vₚ) transformation operator \hat{T}_{T}_{ₖ}_{,p}(Vₚ), which, applied to a topological substructure Tₖ in a molecule G(i) creates in all p positions a topologically equivalent Carbon-analogous substructure T_{C,k}. by morphing each heteroatom into carbon and adjusting changes in valency as needed. Any possible modification including a morphing process in a particular topological subclass Tₖ of the TCC may be generated by formally applying this operator \hat{T}_{T}_{ₖ}_{,p}(Vₚ) for transforming any particular vertex p into a predefined new group Vₚ. We define such a general transformation in terms of a set of basic operators, that either leave the fragment unchanged (i.e. Î, the identity operator is applied), or denote an atomic morphing process (\hat{M}) applied to an atom contained in set Vₚ, which also may imply addition of atoms (default is Hydrogen atom, which is removed in hydrogen depleted graphs) if the morphing process affects valence deficient heteroatoms (Ô₊) and atom deletion (Ô₋) for morphing atoms with “extended” valences at a particular vertex position Vₚ In case of the carbon-morphing procedure, the set of atoms to be created is a single carbon atom in its appropriate valence state. Thus, the morphing operator must comprise two components (operators), one operating on the vertex vₚ(\hat{M}_{T}_{ₖ}_{,V}_{ₚ}), and the other operating on the set of edges Eₚ incident to vₚ (\hat{M}_{T}_{ₖ}_{,E}_{ₚ}). For each of these operators a separate identity operation (Î_{T}_{ₖ}_{,V}_{ₚ}, Î_{T}_{ₖ}_{,E}_{ₚ}) is allowed which enables us to morph the set of atom types while maintaining their valence states and hybridisation as needed (e.g. we distinguish between modifications in saturated systems and (partially) unsaturated substructural elements).

\hat{T}_{T}_{ₖ}_{,p}(Vₚ)∈ {Î,\hat{M},Ô₊,Ô₋} with \hat{M}_{T}_{ₖ}_{,p}(Vₚ)∈ {Î_{T}_{ₖ}_{,V}_{ₚ},\hat{M}_{T}_{ₖ}_{,V}_{ₚ},Î_{T}_{ₖ}_{,E}_{ₚ},\hat{M}_{T}_{ₖ}_{,E}_{ₚ}}

and

\hat{M}_{T}_{ₖ}_{,p}(Vₚ):=\hat{M}_{T}_{ₖ}_{y}_{ₚ}(Vₚ)\mathring{×}\hat{M}_{T}_{ₖ}_{,E}_{ₚ}(Vₚ)

T_{C,k}:=\hat{M}_{T}_{ₖ}_{,p}(Cₚ)\mathring{×}(G(i))

Where Tₖ and T_{C,k} represent the sets of all topological classes and their carbon analogues, respectively.

Thus, the TCC(i) graph for G(i) may be defined as the result of a carbon-morphing process applied to the heteroatom set in the Largest Topological Substructure (LTS), which is generated by eliminating the set S(i) from G(i). Note that the substituent set includes aliphatic substituents of rings and linkers.

LTS(i):=(G(i)\S(i))

TCC(i):=\hat{M}_{LTS,p}(Ĥ(LTS(i))); ∀p ∈ [1,h]

This TCC graph will be labeled by the Topological Sequence Code (TSC) which describes linkage and type of the topological subclasses present (e.g. R₆(L₂-R₆)-L₁-R₆ marks a topological system in which a central six membered ring is connected both by a two bond linker and by a single bond linker to two six membered ring systems). The actual compound being classified will be linked to that TCC as a particular instance for chemical derivatisation of that TCC. Thus, beyond each TCC structure all existing chemical derivatives for that framework present in the input data will be collected as prioritized structure tree leaves (ref. to FIG. 2).

### Detail-Ranking Beyond TCCs

Beyond each TCC node existing structures may be characterized and sorted by structure-based descriptors (e.g. graph invariants). These may be used either

to measure the “chemical distance” (i.e. Mahalanobis distance or euclidic distance) of any compound to the (virtual) cluster centre (the TCC node) or to the centers for the classification categories (i.e. the actives or inactives), and

to sort the chemical derivatives based on that distance, or

for discriminating between chemical modifications in the same TCC with respect to bio-activity and finally

for correlating the calculated descriptors both with physical properties and/or bioactivity data.

As a useful descriptor set applicable for classification and for measuring “chemical distances” within a cluster of compounds or between TST nodes (leaves) the spectral moments of the line graphs or an Iterated series of Line Graphs are considered (ILS) (Estrada E., Generalized Spectral Moments of Iterated Line Graphs Sequence. A Novel Approach to QSPR Studies, J. Chem. Inf. Comput. Sci., 39 (1), 90-95 (1999), Estrada E., Spectral Moments of the Edge Adjacency Matrix of Molecular Graphs. 2. Molecules Containing Heteroatoms and QSAR Applications, J. Chem. Inf. Comput. Sci., 1997, 37, 320-328)) that is defined by

μⱼ(\hat{L}^{k}(G)):=tr(A(\hat{L}^{k}(G)))^{J}j=1, . . . , 15; k>=1

as the trace of j-th power of the square edge (bond-) adjacency matrix A for the k-fold iterated line graph of the original molecular graph G, generated by the k-fold repetitive application of the Line Graph Operator \hat{L},(i.e.\hat{L}^{k}) on the original graph G(i). Note that the operator \hat{L}^{k} used in this context is different from the operator, that creates the linker sets in a graph (see above) and has been retained here for cross reference to other authors. It has been demonstrated by these authors for several datasets, that this procedure does not only generate linear independent descriptors for structure-property analysis, but also allows to discriminate between structural modifications that affect activity or inactivity in bio-assays by applying a linear discriminant analysis procedure (for LDA diagnostics see Lachenbruch P. A., Discriminant Diagnostics, Biometrics, 53, 1284-1292, (1997)).

As part of the post-processing activities on the initial TSF-version for the input data, putative bio-isosteric or iso-functional data for a specific target may be unveiled on the basis of the calculated Mahalanobis distances (Mahalanobis P. C., On the generalized distance in statistics, Proc. Nat. Inst. Sci. India 2, 49-55, [1936]) among different TST-nodes and their subpopulations or by measuring the distance to the centre of the pool for the active compound sets. If distance comparison within subpopulations and among their cluster centres suggest stronger neighborhood than reflected in the rule-based hierarchical tree or show even overlapping parameter spaces the corresponding address links in the TSF may be modified appropriately.

### Installation and Matching of the Topological Sequence Path (TSP) for a Compound in Existing TSTs

All TCC subtrees for all compounds analyzed are collected in dynamic hierarchical Topological Structure Forests or Trees (TSFs or TSTs) which are organized top down for decreasing degree of chemical modification in substructure elements and increasing substructure size in the tree nodes (refer to Moen S, Drawing Dynamic Trees, IEEE Software, July 1990, 21-28) starting with the smallest, but highest scored substructure Tₘ(i) (e.g. a ring or a chain, for acyclic compounds) as the carbon-morphed root node TSPⱼ(i) (i.e. j=1) for the Topological Sequence Path (TSP), creating a valid connected path by joining residual lower priority fragments to TSPⱼ in the order of decreasing scores, which finally ends at the TCC node as the maximal all-carbon substructure in a compound.

Tₘ(i):=Max(score(R₁(i)),score(L₁(i)),score(C₁(i)))

Tₘ(i) ∈ {R₁(i),C₁(i)}

TSP−Root(i):=TSP₁:=\hat{M}_{H,p}(Ĥ(Tₘ(i))), ∀p ∈ [1,h],j=1

Here max(score( ),score( )) is a function, which determines the topological class in a (sub)structure that has highest rank (i.e. Tₘ(i)) according to rules (1)-(5) and a)-d). Starting at the top (root) node of the TST that is the highest scored fragment (i.e. the highest functionalized smallest ring system) in the compound (if no rings are present chains will have top priority), and further shells of topological linkage (i.e. TSPⱼ₊₂, i=1,2, . . . ) will be added sequentially with decreasing score of the fragments involved and after the mophing procedure to carbon has been passed successfully for all h heteroatoms of the fragment with respect to proper carbon atom type and valency.

In Example 1 (FIG. 1) the prioritization process for the topological fragments of an arbitrary input structure is shown and the fragments are labeled with their TSCs and their intra-class priorities.

In Example 2 (FIG. 2) a central aromatic six membered ring labeled R₆(1) has been identified as the TSP-root for input structure 1. The next sphere of topological linkage has the (fragment) Topological Sequence Code (TSC) L₃(1)-R₆(2), which is used to first build the new TST node R₆-L₃-R₆ (i.e. two six-membered aromatic rings connected by a three-bond linker) and finally the last fragment with the TSC L₂(2)-R₆(3) is added to generate the TCC-substructure node labeled R₆(1)-[L₃(1)-R₆(2)]-L₃(2)-R₆(3). For each new compound processed this same procedure will be followed, thus growing the substructure size by adding sequentially spheres of topological linkage from the TSP-root fragment and creating new nodes with their TSC-tags until finally, all topological classes for the molecule have been worked out and the full Topological Sequence Path has been built, which ends in the TCC node beyond which the actual drug instance will be inserted. Due to the intermediate morphing process chemically modified TST-nodes will be identified and correctly assigned to the proper all-carbon TST-node as the common topological cluster centre representing all modified structures of that template type.

TSPⱼ₊₂=TSPⱼ∪\hat{M}_{H,p}(Ĥ(TSPⱼ₊₁(i)))

TSPⱼ₊₁ ∈ Max(score(\hat{T}(TCC\TSPⱼ(i))))

j=1, . . . , (f−2)

score(TSPⱼ₊₁)≦score(TSPⱼ)

Thus, the elements of the topological sets TSPⱼ allow us to define a mapping of the original graph G(i) on a Topological Sequence Path (TSP), in which relationships (e.g. priorities for substructures) among the topological substructures are defined as edges, that connect the nodes of the growing TSP as the substructures in the nodes grow. The recursive relationship for constructing the TSP-vertices from the TSP root gives a shorthand notation for the process of creating these nodes by looping over all topological fragment shells f following the prioritization scheme for the residual fragments to be added. Note, that if a linker is to be assembled for the next substructure, it will be combined immediately with the next ring of highest priority as linkers are allowed to occur only in combination with higher scored ring systems. The new node tags are assembled the same way as the structures by joining the TSC labels of the structural elements being linked, thus creating a unique topological identification tag (TSC or MolCode) for each node in the TSP that starts with the root node label.

We can use these tags for different input data to check the intersection sets for common topological elements in their TSPs, or TSFs in general. Two molecules i,o may have a non-empty intersection set I_{i,o} if and only if they share at least a common TSP-root structure (core).

I_{i,o}:=TSP(i)∩ TSP(o)

The intersection set I_{i,o} may be found by lexical comparison of the TSP-node tags, i.e. R₆-L₂-R₆ and R₆[-L₁-R₆]-L₂-R₆ obviously share both the R₆ root node and the topological sequence R₆-L₂-R₆ and therefore will share these parts in the TST, introducing a branched link at the root node R₆(1). Additional compounds from the pool being analyzed will be processed exactly the same way. This will either inducde the creation of new root nodes for a new TST (then a forest of Topological Structure Trees will be created where the individual trees will be ordered for size of the root nodes) or it will share some of the nodes created for previous molecules. Then additional links to subnodes in the TST will occur at the highest level of topological scoring, where the first and highest ranked differences in scoring and in their associated structural modification occur. In extreme cases differences may be found only at the level of the TCC, which means that different functional instances (derivatives) of the same template have been identified and a previously existing gap for this template has been closed. This behaviour is desired in course of SAR analysis for active/inactive hit lists.

Instead of lexical comparisons in search for intersecting elements well-known other techniques such as clique detection, maximimum common substructure search or fingerprint screening may prove useful.

### Storing and Managing of Analysis Data in the TST Nodes

Additional information fields may contain bio-activity reference to all test systems (bio-profiling) in which such a template has been found active (refer to privileged templates or scaffolds). These information fields can be attached to the actual molecular graph, which is linked either as a regular TST node or as a leaf node beyond the TCC node for monitoring enrichment factors, for use in process management based on decision trees or for applying alternate data partitioning schemes. Based on these information arrays the subsequent tasks may be processed efficiently:

SAR profiling for topological scaffolds for R-group deconvolution of actives/inactives

framework-based likelihood analysis for bio-activity by Bayesian statistics for scaffolds

checks on putative false positives/negatives by applying boolean operations to TSTs generated from different filters for input data.

gap analysis for active template classes, screening pool, compound repositories, privileged scaffolds in bio-profiles over HTS-history and purchase list selection.

(regularised) Discriminant analysis for bio-activity or physical properties based on calculated graph invariants for the structures such as the spectral moments

calculation of chemical distances between TST nodes via the Mahalanobis distance metric.

Include patent structures and SARs for structure focused knowledge extraction

selection of target specific but structurally diverse topological and functional prototype molecules for 3D alignment and mechanistic analysis of drug/target interaction (identification of bio-isosteric and isofunctional groups).

comparative analysis of bio-effector databases and inhouse molecular frameworks for active screening hits (indirect target analysis)

use of scaffolds for retrosynthesis planning and reaction library searches

### Comparing Active and Inactive TSTs

Due to use of a chemically meaningful Topological Sequence Codes (TSC) and MolCodes in the Topological Structure Forests for active and inactive compounds in a specific test system, corresponding populations in both data sets may be identified easily by their identical node tags (TSCs or MolCodes). Thus, the effect of chemical modification on activity/inactivity in the assay may be recognized for identical topological frameworks and supports subsequent pharmacophore analysis, SAR and structure property analysis in general. Further analysis may be done by comparing calculated compound descriptors or by further categorizing substituents and heteroatoms present in these “clusters” (e.g. by classifying in HB donors or acceptors, ionizable acidic/basic groups etc.) to find those partners in both groups (actives/inactives, respectively) that share most of their chemical features besides their common topological frameworks. This set of compounds is considered to represent most likely candidates for false positives or false negatives in testing, depending on the actual probability distribution in the individual groups of actives/inactives which should be scheduled for retesting. By analyzing all matching TCCs in both sets, the set of compounds to be retested is identified and hypotheses for chemical modifications causing activity/inactivity may be generated on the fly. Information on consensus pharmacophore elements may be generated and R-group deconvolution for the TCCs may be achieved for each template by processing the compound lists attached to each TCC in search for patterns of substitution. Further analysis/proof for the pharmacophore candidates (bio-active fragments) may be achieved based on (regularized) discriminant analysis (Friedman J. H., Regularized Discriminant Analysis, Journal of the American Statistical Ass., 1989, 84(405), 165-175) with the spectral moments and the Mahalanobis distance calculated for the individual compounds and fragmentation schemes relative to the active/inactive categories in a training subset (Estrada E., On the Topological Sub-Structural Molecular Design (TOSS-Mode) in QSPR/QSAR and Drug Design Research, SAR and QSAR in Environmental Research, 2000, 11, 55-73.). The fragmentation schemes may be evaluated by Leave-one-out (LOO) crossvalidation runs and predictivity analysis with a sample test subset.

As an alternate method for validating pharmacophore fragmentations the SIMCA method (Wold S and Sjostrom M in “Chemometrics: Theory and Application”, Kowalski, B. R. (Ed.), ACS Washington, 1977) or the HQSAR-method (U.S. Pat. No. 5,751,605) might be applied.

### Gap Analysis for Topological Frameworks

Beyond any TCC-node each member of the set D of chemical derivatives is placed as individual leaf in the Topological Structure Tree. D partitions the chemistry space below the TCC node into two subgroups: the part actually occuppied and its complement to all possible variations in that TCC. The same is valid for any node above the TCC and its child nodes (subtrees). Any possible modification in a particular topological subclass Tₖ of the TCC may be generated by formally applying the operator \hat{T}_{T}_{ₖ}_{,p}(Vₚ) for transforming any particular position p into a predefined new group Vₚ. By applying such an operator to any particular class Tₖ in the TCC node or the actual molecular graph G(i) we can formally enumerate any new compound G′.

G′(i):=\hat{T}_{T}_{ₖ}_{,p}(Vₚ)\hat{×}G(i)

The virtual chemistry space defined by the TCC and a subset Tₖ is called X_{T}_{ₖ} and comprises all chemically possible point transformations at positions p in a given template.

$${X}_{{T}_{k}} := {\prod }_{p , {V}_{p}} ( {\hat{T}}_{{T}_{k} , p} ( {V}_{p} ) ) ⊗ TCC$$

The missing complement to the actually occupied chemistry space comprises all gaps in that particular topological chemistry subspace in terms of new compounds M_{T}_{ₖ} as defined by

M_{T}_{ₖ}:=X_{T}_{ₖ}\D_{T}_{ₖ} where D_{T}_{ₖ} is the occupied chemistry space of existing derivatives in subclass Tₖ. Of course, further filter activities due to chemical feasibility for synthesis, desirable physical properties and presence of the required pharmacophore spectrum or lack of reactive groups should be performed to increase efficiency of the procedure.

The list of positions p and atom sets Vₚ to be scanned for new compounds may be derived from the available sets of heteroatoms H and substituents S present in D and/or from user selections. In practice, these operations make only sense if the filter for the input data for which topology analysis is to be done has been set properly (i.e. it should be set to “repository analysis”). The set of topological classes accessible to machine-based modifications in structure and type may be handled by filter lists for exclusion and by additional rules (sets) for the actual chemical modifications to be applied. The practical performance of the morphing procedure may be simplified by transforming the TCCs into a lexical structure code (e.g. SLN or Smiles etc.) to arrange the actual structural modifications more easily for end-users.

Easier gap filling is achievable by comparing TSTs for existing chemical repositories with actual purchase lists as similarly described above for comparing active and inactive compounds.

### EXAMPLE 1

FIG. 1: illustrates selected steps for topology analysis in compounds and intermediate results generated from an example input structure 1 by applying the operating procedure steps (I.-VII.), prioritizing rules (1)-(5) and a)-d) in the recursive structural partitioning scheme for topological features, X represents an arbitrary heteroatom.

First the hydrogen-depleted graph (2) is generated, then the topological classes of the compound (shown color coded for their atom types) are processed sequentially, starting with the highest priority class e.g. rings (colored red, 3), proceeding through linkers (blue), heteroatoms (pale green) and substituents (or functional groups, orange, 4). For readability in black and white printings, the proper topological atom labels that define ring, linker and chain membership are also given for each substructure element. In course of this process the intra-class prioritization is determined for all classes sequentially. The final result of the overall fragment prioritization is attached to the vertices of the topological subclasses as a vertex label (5,6). In the final step the structure for the (virtual) Topological Cluster Centre (TCC, green 7) is created, which serves as the parent node for all chemical modifications of that scaffold.

### EXAMPLE 2

Example for constructing the Topological Sequence Path (TSP) for compound 1 which has been processed as displayed in FIG. 1 (X=arbitrary heteroatom). Putative links to close topological neighbors that may be present in the input data but are not yet attached have been indicated by dashed double headed arrows that mark possible linkage at any intermediate level of detail in the TST. Double headed arrows indicate pointer information that allows for traversing up and down in Topological Structure Trees. Lowest level of detail (TST-root, red, 8) is the general six-membered ring which has top priority. From this extension of topological spheres around this central framework enlarges the structure by levels of detail following the rule-based prioritization scheme. Attached to the nodes of the TST are the Topological Sequence Code (TSC) Labels (in red) which may be used in place of the graphs (structures) to navigate through large scale data sets and through very complex Topological Structure Forests (collections of different TSTs with different root structures). Also to each node in the TST analysis fields may be attached which allow for book-keeping activities on subtree populations, bio-data (activity/inactivity) for screens (bio-profiles) etc. Note that beyond each node the actual instances of chemical variation are enumerated which also define topological gaps and derivatives by their enumerable complement to the actual possible variations in the topological subclasses of these subtrees. TCC structures (e.g. 7) may be considered ideal tools for retrosynthetic synthesis planning, reaction library searches and for comparing SARs among different scaffolds.

### EXAMPLE 3

The input data for a Dopamine D1 and D2 agonist set taken from literature (Wilcox R. E., Tseng T., Brusniak M. K., Ginsburg B., Pearlman R. S. Teeter M., Durand C., Starr S. and Neve K. A., CoMFA-based prediction of agonist affinities at recombinant D1 vs D2 dopamine receptors, J. Med. Chem., 1998, 41, 4385-4399) are shown in FIG. 3. Structures are coded in SLN (Sybyl Line Notation, Tripos Inc. St. Louis), but Sybyl Mol2 files, MDL Mol files, Smiles format or SLN may be used in general for creating Topological Structure Trees using an in-house computer-program, which is based on the invention described herein.

### EXAMPLE 4

FIG. 4 shows the result for an automatically produced TSF generated by an inhouse computer-program, which is based on the invention described herein, demonstrating some of the methods described in this patent for the data from Example 3.

A computer-program can be programmed such that it

a) allows the user to navigate interactively through the topological tree in search of the most promissing templates for synthetic work,

b) color codes the nodes either for bio-activity (or a given other physical property spectrum) or for statistical data derived for Templates or Scaffolds and the properties of the compound nodes for derivatives in subtrees and

c) enumerates the available derivatives present in the dataset for each Topological Cluster Centre for identification of drug candidate gaps.

Except for the tree leaves (which are tagged by their compound name or registration id) the Topological Sequence Code (node label) is placed above each structure (tree node).

1. Method for structure based information processing of structurally characterised chemical compounds, wherein
a) the molecular graph of each 2D- or 3D-structure for a chemical compound is analyzed in terms of topological key features,
b) the Largest Topological Substructure (LTS) and the proper Topological Cluster Centre (TCC) are created for each molecular graph,
c) the ranking of the classes of topological key features and/or the ranking within each class of topological key features present in the TCC is used to generate a connected hierarchical Topological Sequence Path (TSP) of sentinel molecules from each molecular graph, and
d) different molecular graphs and their Topological Sequence Paths (TSPs) share common vertices for common topological key features thus growing a Topological Structure Tree (TST),
e) each chemical compound from the input stream is attached as a leaf node to the appropriate Largest Topological Substructure (LTS) node in the tree.

2. Method according to claim 1, characterized in that representative name tags are created, that label each substructural node in the Topological Sequence Path (TSP).

3. Method according to claim 1, characterized in that a representative name tag is a characteristic MolCode.

4. Method according to claim 3, characterized in that the MolCode is generated by applying a rule-based prioritisation scheme for constructing the substructure name tag that typifies the Topological Cluster Centre (TCC) of any compound by the topological key features present.

5. Method according to claim 3 or 4, characterized in that each compound after transformation to the Topological Cluster Centre (TCC) is partitioned into an ordered list of MolCodes representing a full Topological Sequence Code (TSC) for all embedded substructures of a compound as defined by its Topological Sequence Path (TSP).

6. Method according to one of the claims 3 to 5, characterized in that the MolCodes for all template nodes along the Topological Sequence Path (TSP) are constructed from the MolCode for the Topological Cluster Centre (TCC) by first naming the top prioritized core template and concatenating this MolCode with MolCode strings for the succeedingly ranked topology features in the Topological Cluster Centre (TCC).

7. Method according to one of the claims 3 to 6, characterized in that MolCodes for chemical derivatives may be generated by adding chemical modifiers to the topological line code for the templates to specif,y which chemical transformation has been applied for any particular topological substructure element.

8. Method according to one of the claims 1 to 7, characterized in that the topological key features comprise one or several topological classes selected from the group consisting essentially of rings, linkers, heteroatoms, substituents and/or acyclic chains.

9. Method according to one of the claims 1 to 8, characterized in that the ranking used for the classes of the topological key features is defined with decreasing priority by the heuristic rule: rings>linkers>heteroatoms>substituents>chains.

10. Method according to one of the claims 1 to 9, characterized in that intra- and inter class ranking of the topological key features is achieved as a rule-based system for
A) ranking the relative importance of the subclasses of the topological key features in terms of degree of substitution and
B) deriving criteria to estimate the significance of any particular chemical modification in a specific fragment with respect to fragment size and geometric flexibility in the spatial 3D-conformation for that fragment

11. Method according to one of the claims 3 to 10, characterized in that the MolCode is used to identify in different molecular graphs those topological key features they actually share by applying boolean operations on corresponding subtree nodes defined by their Topological Sequence Codes (TSCs) or Topological Sequence Paths (TSPs).

12. Method according to one of the claims 1 to 11, characterized in that for molecular graphs containing topologically unique templates not shared with other molecular graphs new non-overlapping Topological Sequence Paths (TSPs) are created as parts of dynamic Topological Structure Forrests (TSFs) built from individual a Topological Structure Trees (TSTs).

13. Method according to one of the claims 1 to 12, characterized in that the Topological Sequence Paths (TSPs) for the molecular graphs are visualized graphically as dynamic Topological Structure Forrests (TSFs) and Topological Structure Trees (TSTs) of tree-structured nodes or their equivalent MolCodes.

14. Method according to one of the claims 3 to 13, characterized in that the structures of the nodes in the Topological Sequence Path (TSP) and their MolCodes are linked to statistical data for bio-activity testing at one or more biological targets or measured or calculated properties/descriptors.

15. Method according to claim 14, characterized in that the statistical data or the properties/descriptors are used for coloring the structures or rearranging structures in the Topological Structure Trees (TSTs) or for measuring descriptor-based chemical distances among structures, substructures and/or groups of classified data.

16. Method according to claim 14, characterized in that the statistical data or the properties/descriptors are used for mapping a color spectrum to the nodes and structures thus generating coloured Topological Structure Trees (TSTs) and Topological Structure Forrests (TSFs), that quantify the target-oriented potential present in templates, scaffolds, topological fragments and chemical derivatives.

17. Method according to cone of the claims 14 to 16, characterized in that the statistical data can be frequency distributions, probabilities and/or enrichment factors.

18. Method according to one of the claims 1 to 17, characterized in that the chemical compounds originate from structural databases for compound testing in High Throughput/Ultra High Throughput Screens, Natural substance screens, databases for edogenous bio-effectors or comparable data from literature or published patent applications for drug finding or drug optimisation processes.

19. Utilization of the method according to the claims 1 to 18 to identify structural or topological and/or functional gaps in a set of chemical compounds, characterized by the additional step of
a) modifying the topological key features in any node or its corresponding MolCode, that is part of the molecular Topological Sequence Path (TSP) and identifying topological and functional gaps by comparing new modified substructures (or their MolCodes) with those for existing tree nodes, or
b) providing Topological Sequence Paths (TSPs) for molecular graphs of chemical compounds in commercial compound databases and identifying topological and functional gaps by comparing the MolCodes for these provided Topological Sequence Paths (TSPs) with those of the already existing tree nodes.

20. Utilization of the method according to the claims 1 to 18 to generate computer-based compound selections, characterized by the additional steps of
a) using graph-based descriptors for the nodes of the Topological Sequence Paths (TSPs) to classify properties and/or bioactivities,
b) ranking the contribution to bio-activity classification for chemical templates or subsets thereof and their derivatives,
c) generating consensus pharmacophore or toxophore information by using the Topological Structure Trees (TSTs) or Topological Structure Forrests (TSFs) from active and inactive compounds and positioning the functional derivatives beyond the nodes in their Topological Sequence Paths (TSPs) and/or
d) generating chemical activity profiles or statistical analyses for one or more biological targets such as screening profiles by using the a Topological Structure Tree (TSTs) or Topological Structure Forrests (TSFs) for active and inactive compounds and the functional derivatives placed beyond the Largest Topological Substructure (LTS) or Topological Cluster Centre (TCC) nodes.

21. Utilization according to claim 20, characterized in that the graph-based descriptors include spectral moments or other graph-invariant properties for calculating classification probabilities or chemical distances among classes, representative substructures, individual compounds or categories for target modulators in general.

22. Utilization according to claim 20 or 21, characterized in that the bio-activity classification is done by Discriminant analysis or by any equivalent method or algorithm for property classification.

23. Utilization according to one of the claims 1 to 18, characterized in that the MolCode or the corresponding templates are used to identify in different compounds those topological key features, which are unique in active and/or inactive compounds in one or more biological tests in search for specific, promiscuous or privileged chamical templates and scaffolds.

24. Utilization of the method according to the claims 1 to 18 to perform a computer-based simultaneous R-group deconvolution for all existing templates and substructures in a given input data set, characterized by the additional step of substracting available substituents from the chemical space defined for each topologically unique template or its equivalent MolCodes.
